(19) United States
(12) Patent Application Publication
(10) Pub. No.: US 2025/0328164 A1
(43) Pub. Date: Oct. 23, 2025

(54) DOCK WITH A ROTATABLE MOUNT FOR MOBILE DEVICES AND METHODS OF MAKING AND USING

(71) Applicant: National Products, Inc., Seattle, WA (US)

(72) Inventor: Jeffrey D. Carnevali, Seattle, WA (US)

(21) Appl. No.: 18/638,430

(22) Filed: Apr. 17, 2024

(51) Int. Cl. G06F 1/16

(52) U.S. Cl. CPC G06F 1/1632

(57) ABSTRACT

A dock for a mobile device includes a base for attachment to a wall or other surface; a rotatable mount rotatably coupled to the base, the rotatable mount including an anchoring mount and a bottom device receiver, the rotatable mount further including either a) a docking button indentation for receiving a docking button coupled to the mobile device or b) a docking button extending from a remainder of the anchoring mount, wherein at least one of the bottom device receiver, the docking button indentation, or the docking button includes a plurality of electrical contacts for making contact with contacts on the mobile device or the case; and a cord electrically coupled to at least one of the electrical contacts, extending into the base, and configured for coupling to a power source, a data source, or a data receiver.

### FIELD

The present invention is directed to a dock with a rotatable mount for a mobile device. The present invention is also directed to a dock for a mobile device that is capable of mounting on a wall or other surface.

### BACKGROUND

Mobile devices, such as smartphones, cellular or mobile phones, tablets, personal data assistants, and other portable devices, are now ubiquitous. Docks can be used to protect the mobile device, to mount the mobile device onto a surface or object, or to provide power, or data to or from, the mobile device, or any combination thereof.

### BRIEF SUMMARY

One embodiment is a dock for a mobile device. The dock includes a base configured for attachment to a wall or other surface; a rotatable mount rotatably coupled to the base, the rotatable mount including an anchoring mount and a bottom device receiver coupled to the anchoring mount, wherein the rotatable mount further includes either a) a docking button indentation defined in the anchoring mount and configured for receiving a docking button coupled to the mobile device or b) a docking button extending from a remainder of the anchoring mount, wherein the bottom device receiver is configured to receive a bottom portion of the mobile device or a case containing the mobile device, wherein at least one of the bottom device receiver, the docking button indentation, or the docking button includes a plurality of electrical contacts configured for making contact with contacts on the mobile device or the case containing the mobile device; and a cord electrically coupled to at least one of the electrical contacts, extending into the base, and configured for coupling to a power source, a data source, or a data receiver.

Another embodiment is a dock for a mobile device. The dock includes a base configured for attachment to a wall or other surface; a rotatable mount rotatably coupled to the base, the rotatable mount including an anchoring mount and a bottom device receiver coupled to the anchoring mount, the anchoring mount defining a docking button indentation for receiving a docking button coupled to the mobile device, wherein the bottom device receiver includes a plurality of electrical contacts configured for making contact with contacts on the mobile device or the case containing the mobile device; and a cord electrically coupled to at least one of the electrical contacts, extending into the base, and configured for coupling to a power source, a data source, or a data receiver.

In at least some embodiments, the base includes a wall box configured for insertion into a wall or other surface. In at least some embodiments, the base further includes a power supply or a power over internet (PoE) injector, wherein the power supply or POE injector is electrically coupled to the cord.

In at least some embodiments, the docking button indentation has a polygonal lateral cross-sectional shape. In at least some embodiments, the polygonal lateral cross-sectional shape is selected from triangular, square, rectangular, rhomboidal, trapezoidal, pentagonal, hexagonal, octagonal, or decagonal.

In at least some embodiments, one of the base or rotatable mount defines a track and another one of the base or rotatable mount defines a pin arranged for traveling along the track to limit rotation of the rotatable mount relative to the base. In at least some embodiments, the rotatable mount or base is capable of, and limited to, a rotation of 180 degrees. In at least some embodiments, the rotatable mount or base is capable of, and limited to, a rotation of 90 degrees.

In at least some embodiments, the base and rotatable mount include at least one detent for maintaining at least one desired rotation position of the rotatable mount relative to the base. In at least some embodiments, the docking button indentation or docking button includes a magnet or magnetically-attracted piece configured for magnetically coupling to a magnet or magnetically-attracted piece of the mobile device or case containing the mobile device to removably attach the mobile device to the dock.

A further embodiment is a system that includes any of the docks described above and the mobile device.

Yet another embodiment is a method for attaching a mobile device to a wall or other surface. The method includes removably attaching the mobile device to the dock of claim 1 which is attached to the wall or other surface and rotating the mobile device, while attached to the dock, relative to the wall or other surface.

In at least some embodiments, rotating the mobile device comprises rotating the mobile device at least 90 degrees. In at least some embodiments, the method further includes charging the mobile device using the dock.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1A is a schematic perspective side view of one embodiment of a dock for a mobile device, according to the invention;

FIG. 1B is a schematic perspective side view of one embodiment of a body of the dock of FIG. 1A;

FIG. 1C is a schematic perspective bottom view of one embodiment of a rotatable mount of the dock of FIG. 1A;

FIG. 1D is a schematic partial cross-sectional perspective side view of one embodiment of the dock of FIG. 1A;

FIG. 1E is a schematic cross-sectional perspective bottom view of one embodiment of the dock of FIG. 1A;

FIG. 2A is a schematic perspective front view of a mobile device contained within a case and attached to the dock of FIG. 1A, according to the invention;

FIG. 2B is a schematic perspective front view of the mobile device contained within the case and attached to the dock of FIG. 1A, according to the invention;

FIG. 2C is a schematic perspective side view of the mobile device contained within the case and attached to the dock of FIG. 1A, according to the invention;

FIG. 2D is a schematic perspective side view of the mobile device contained within the case prior to attachment to the dock of FIG. 1A, according to the invention;

FIG. 2E is a schematic cross-sectional side view of the mobile device contained within the case and attached to the dock of FIG. 1A, according to the invention;

FIG. 3A is a schematic back view of the mobile device attached to the dock of FIG. 1A in a horizontal position (relative to the page), according to the invention; and

FIG. 3B is a schematic back view of the mobile device attached to the dock of FIG. 1A in a vertical position (relative to the page), according to the invention.

### DETAILED DESCRIPTION

The present invention is directed to a dock with a rotatable mount for a mobile device. The present invention is also directed to a dock for a mobile device that is capable of mounting on a wall or other surface.

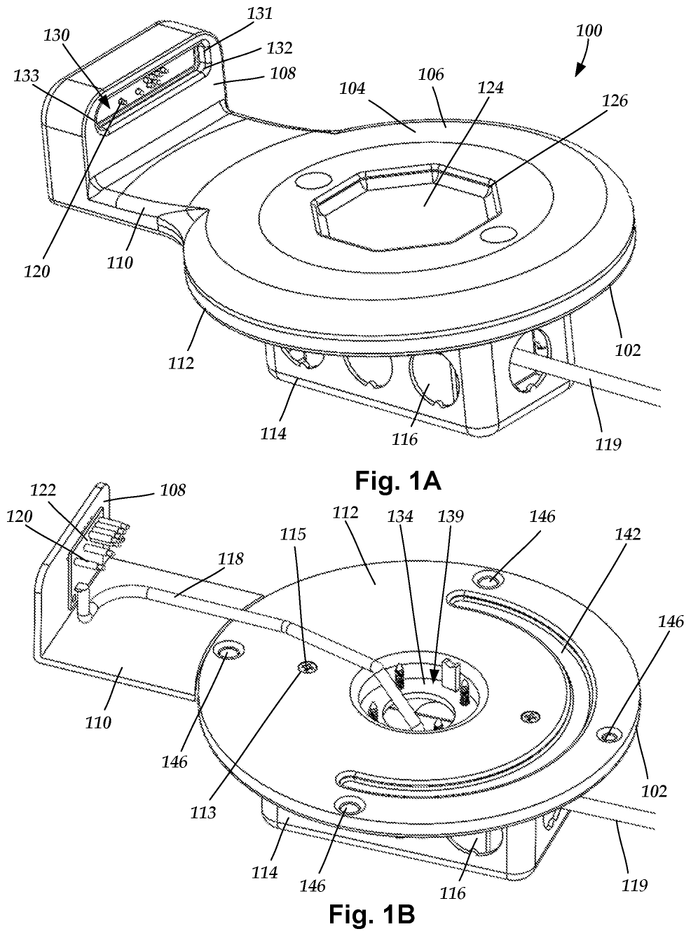

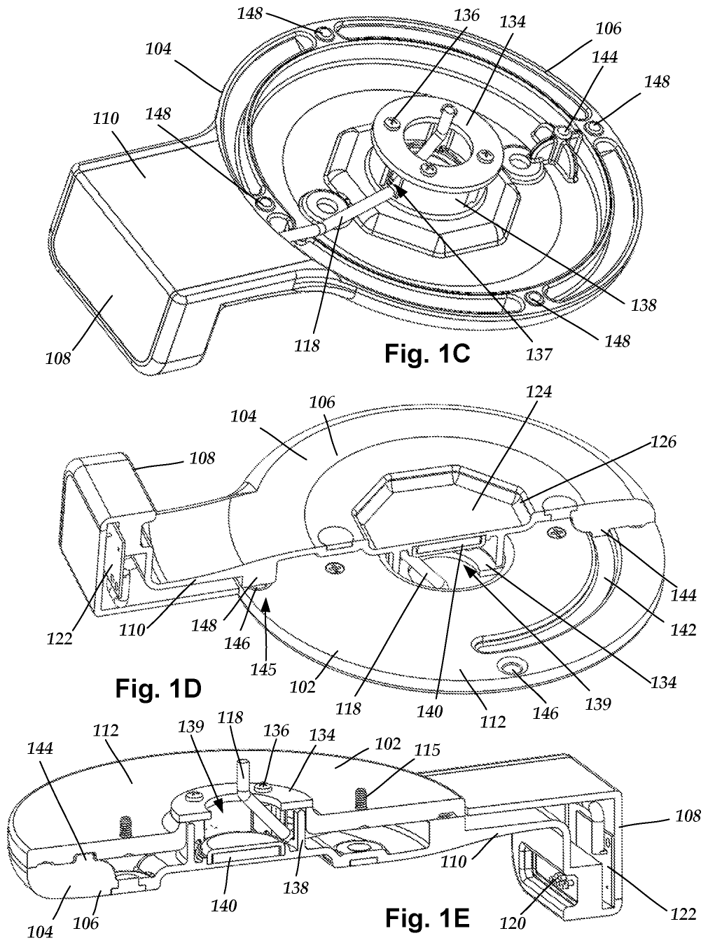

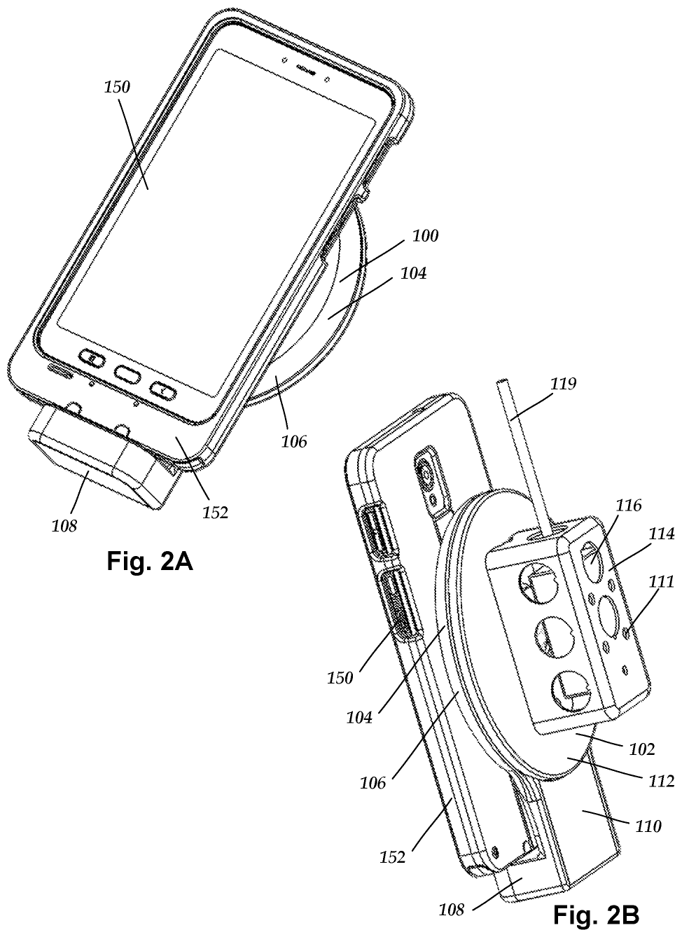

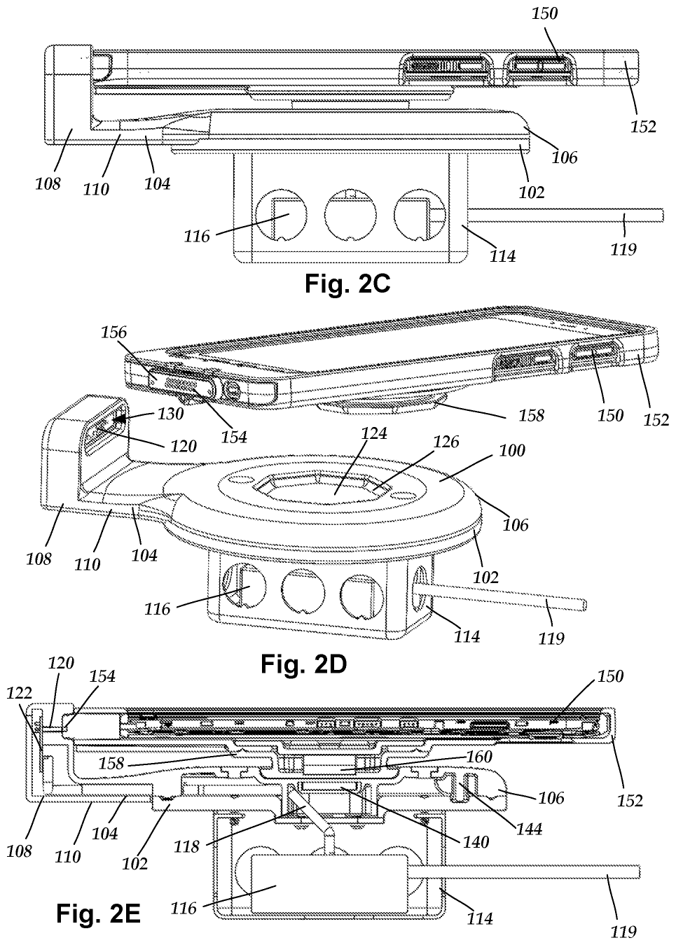

FIGS. 1A to 1E illustrate one embodiment of a dock 100 for a mobile device 150 (FIG. 2A), such as a cellular or mobile phone, a smartphone, a tablet, a personal data assistant, or any other suitable mobile device. The dock 100 includes a base 102 for attachment to a wall or other surface and a rotatable mount 104 coupled to, and rotatable relative to, the base. The rotatable mount 104 includes an anchoring body 106 for attachment of the mobile device to the dock and a bottom device receiver 108 that is coupled directly or indirectly (e.g., through a neck 110) to the anchoring body and arranged for receiving a bottom side of the mobile device. FIG. 1B illustrates one embodiment of the base 102. FIG. 1C illustrates one embodiment of the rotatable mount 104. FIGS. 1D and 1E are respectively partial and full cross-sectional views of at least a portion of the dock 100. FIGS. 2A to 2C illustrate a mobile device 150 contained within a case 152 and attached to the dock 100. FIG. 2D illustrates the mobile device 150 prior to being received by the dock 100. FIG. 2E is a cross-sectional view of the mobile device 150 and dock 100.

In at least some embodiments, the base 102 is mountable to a wall or other surface so that the mobile device 150, anchored or otherwise attached to the rotatable mount 104, can be rotated relative to the wall or other surface while remaining attached to the wall or other surface. In at least some embodiments, the base 102 includes a panel 112 and a wall box 114. In at least some embodiments, a power supply 116 or other power source, such as a power over ethernet (POE) injector), is disposed in the wall box 114 as illustrated in FIG. 1B. In at least some embodiments, the dock 100 does not include a wall box 114 such as, for example, in situations where electrical codes do not require a wall box or where the power source or other coupling for the dock is a POE injector, a low voltage source or coupling, a data coupling, or the like or any combination thereof.

In a least some embodiments, the wall box 114 is configured for insertion into an opening in a wall or other surface, for example, an opening for a wall power outlet or the like. In at least some embodiments, the wall box 114 includes one or more openings 111 for receiving a fastener 115, such as a nail, bolt, screw, or the like, for fastening the wall box to the wall or other surface. Alternatively or additionally, the panel 112 includes one or more openings for receiving a fastener, such as a nail, bolt, screw, or the like, for fastening the panel to the wall or other surface. In at least some embodiments, the panel 112 can include one or more openings 113 and one or more fasteners 115, such as, for example, screws, bolts, pins, tabs, or the like, for attaching the wall box 114 to the panel 112.

The dock 100 includes a cord 118 extending from the bottom device receiver 108 through the base 102. In at least some embodiments, the cord 118 is coupled to a power supply 116 (or PoE injector or other power source or data source) disposed in the wall box 114. The cord can be hardwired to the power supply 116 (or POE injector or other power source or data source) or can have a connector for coupling to a connector of the power supply 116 (or POE injector or other power source or data source). In at least some embodiments, the power supply 116 is coupled to another cord 119 that extends directly or indirectly from a power source to the power supply 116. In at least some embodiments, the power supply 116 or other power source can also be a data source or data receiver or can be coupled to a data source or a data receiver (for example, via an ethernet cable or other connection). In at least some embodiments, the power supply 116 or other power source is replaced by, or accompanied by, a data source or data receiver or a connector, coupled or coupleable, to a data source or a data receiver. The cords 118, 119 can be used to provide power or data or both to, or from, the mobile device 150 via the dock 100.

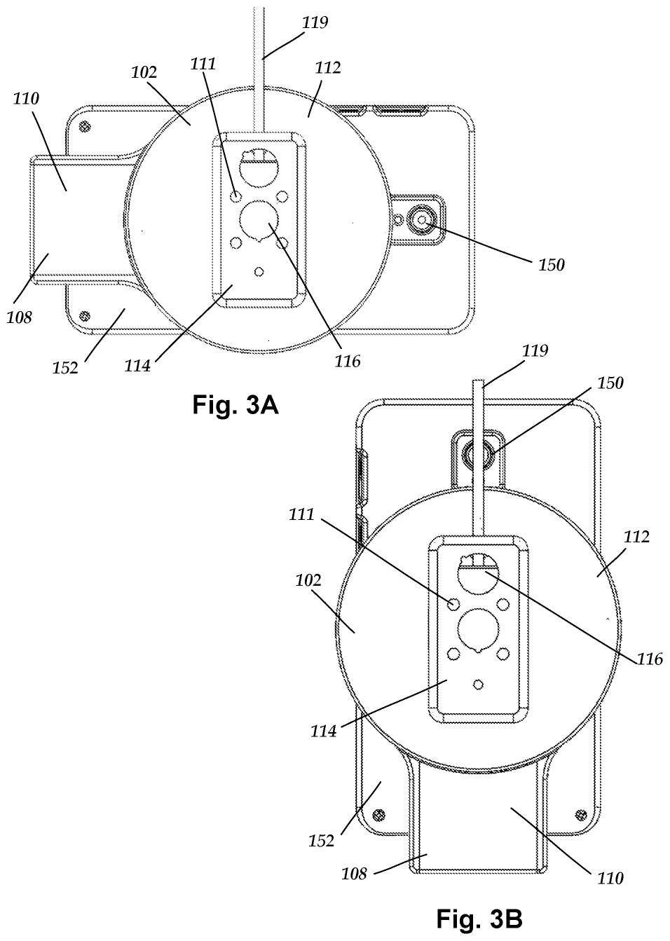

The bottom device receiver 108 is attached to the anchoring body 106 directly or indirectly through an optional neck 110. The bottom device receiver 108 may be integrally formed with (e.g., permanently attached to or permanently part of) the anchoring body 106 (or the neck 110 or both) or may be detachable from the anchoring body (or the neck). In at least some embodiments, the bottom device receiver 108 includes one or more contacts 120 for making electrical contact with contacts 154 (FIG. 2D) of a mobile device 150 (FIG. 3A) or a case 152 (FIG. 3A) containing the mobile device. The contacts 120 are electrically coupled to the cord 110 to provide power to the mobile device 150 or provide data to or from the mobile device or any combination thereof. The contacts 120 may be disposed on, or attached to, a substrate 122, such as, for example, a printed circuit board with the bottom device receiver 108 forming a housing around the substrate.

Any arrangement of the contacts 120 can be used including, but not limited to, an arrangement of the contacts in one or more rows. When the arrangement includes two or more rows, the contacts in the rows can be aligned or staggered relative to each other. In other embodiments of the dock 100, the contacts 120 can be positioned anywhere in or on the rotatable mount 104 such as, for example, in or on the anchoring body 106. In at least some embodiments, the contacts 120 are pogo pins or other biasing contacts that can move up or down relative to the rotatable mount 104 such as, for example, the bottom device receiver 108.

The contacts 120 make electrical contact with contacts 154 (FIG. 2D) on the mobile device 150 or a case 152 disposed on the mobile device when the mobile device is inserted into (e.g., received by) the dock 100. Examples of cases with contacts include, but are not limited to, the cases, covers, or skins described in U.S. Pat. Nos. 9,195,279; 9,331,444; 9,529,387; 9,602,639; 9,632,535; 9,706,026; 10,050,658; 10,054,984; 10,389,399; 10,454,515; and 10,630,334 and U.S. patent application Ser. Nos. 16/853,544 and 16/866,156, all of which are incorporated herein by reference in their entireties. The contacts 120 of the dock 100 can be used to provide power to the mobile device 150 from a power source, transfer data between the mobile device and a data source or data receiver, or any combination of these functions.

In at least some embodiments, the bottom device receiver 108 forms a housing (e.g., for the substrate 122 and a portion of the cord 118) that defines a recess 130 surrounded by a rim 132 that may facilitate retention of the mobile device in the dock 100. In at least some embodiments, the recess 130, rim 132, and contacts 120 define a female connector. In at least some embodiments, the shape of the recess 130 and rim 132 are complementary to a male structure 156 (FIG. 2D) of a case 152 (see, for example, the cases, covers, or skins in the references cited above) or mobile device 150. In at least some embodiments, the recess 130 and rim 132 have a straight side 131 and an opposing curved side 133 to or other asymmetric shape.

In at least some embodiments, the anchoring body 106 defines a docking button indentation 124 to receive a docking button 158 (FIG. 2D) attached to the mobile device 150 or a case 152 containing the mobile device. In other embodiments, the anchoring body 106 includes a docking button and the mobile device 150 or case 152 defines the docking button indentation. Non-limiting examples of docking buttons 158 and docking button indentations 124 can be found in U.S. patent application Ser. No. 18/612,977, which is incorporated herein by reference in its entirety.

In at least some embodiments, the docking button indentation 124 of the anchoring body 106 has an indentation perimeter 126 and a lateral cross-sectional shape and the docking button 158 has a lateral cross-sectional shape complementary to the indentation perimeter or the lateral cross-sectional shape of the docking button indentation. In at least some embodiments, the docking button indentation 124 has a non-circular indentation perimeter 126 or non-circular lateral cross-sectional shape and the docking button 158 has a non-circular lateral cross-sectional shape. In at least some embodiments, the non-circular shapes facilitate maintaining alignment of the mobile device 150 with the dock 100 because the docking button 158 is not rotatable within the docking button indentation 124. Examples of indentation perimeter shapes and lateral cross-sectional shapes of a docking button indentation 124, as well as lateral cross-sectional shapes of a docking button 158, include, but are not limited to, circular, oval, triangular, square, rectangular, rhomboidal, trapezoidal, pentagonal, hexagonal, octagonal (as illustrated in FIG. 1A), decagonal, or the like. In at least some embodiments, the indentation perimeter shape and lateral cross-sectional shape of the docking button indentation 124 and the lateral cross-sectional shape of the docking button 158 are polygonal, regular polygonal, or irregular polygonal. In at least some embodiments, the indentation perimeter shape and lateral cross-sectional shape of the docking button indentation 124 and the cross-sectional shape of the docking button 158 facilitate retention or alignment of the mobile device 150 on the dock 100.

It will also be understood that the docking button indentation 124 and docking button 158 can include contacts in addition to, or as an alternative to, the contacts 120 of the dock 100 and contacts 154 at the bottom of the mobile device 150 or case 152 to provide power to the mobile device or transfer data to or from the mobile device. Non-limiting examples of docking buttons 158 and docking button indentations 124 with contacts can be found in U.S. patent application Ser. No. 18/612,977, which is incorporated herein by reference in its entirety.

FIG. 2E illustrates one embodiment of the attachment of the docking indentation 124 of the dock 100 to the docking button 158 of the mobile device 150 or case 152 using one or more magnets 140 in the dock and one or more magnets 160 in the mobile device or case. In at least some embodiments, one or more of the magnets 140 or the magnets 160 are individually replaced with a magnetically-attracted piece, such as an iron, steel, nickel, or cobalt piece or the like, so that there is at least one complementary magnet/magnetically-attracted-piece pair when the dock 100 is coupled to the mobile device 150 or case 152. In at least some embodiments, the magnets 140, 160 (and magnetically-attracted pieces) are fully or partially embedded in the material of the dock 100 or mobile device 150 or case 152. Any other suitable arrangement can be used to couple the docking indentation 124 of the dock 100 to the docking button 158 of the mobile device 150 or case 152 including any suitable mechanical coupling arrangement, such as, for example, a latch as described in U.S. patent application Ser. No. 18/612,977, which is incorporated herein by reference in its entirety.

The rotatable mount 104 is rotatable relative to the base 102, as illustrated in FIGS. 3A and 3B, in which the mobile device 150 is rotated by at least 90 or 180 degrees. For example, FIGS. 3A and 3B illustrate the mobile device 150 in a horizontal or vertical position (from the perspective of the page of the Figures).

Any mechanism can be used to provide a rotational coupling between the body 102 and the rotatable mount 104. In the illustrated embodiment, the dock 100 includes a mounting ring 134 that is attached to the rotatable mount 104 by one or more fasteners 136 and which rotatably attaches the rotatable mount 104 to the body 102, as illustrated in FIG. 1E. In the illustrated embodiment, the mounting ring 134 is a ring that attaches to a flange 138 of the anchoring body 106 of the rotatable mount 104 using the fasteners, as illustrated in FIG. 1C. The flange 138 of the anchoring body 106 of the rotatable mount 104 has a diameter selected so that the flange can extend into an opening 139 defined by the panel 112 of the body 102. The mounting ring 134 has an outer diameter larger than the outer diameter of the opening 139. In at least some embodiments, the flange 138 includes one or more openings 137 for passage of the cord 118 through the flange 138 into the opening 139 to allow passage of the cord through the body 102 of the dock 100, as illustrated in FIG. 1C.

In the illustrated embodiment of FIGS. 1A to 1D, the panel 112 includes at least one track 142 (FIGS. 1B and 1D), such as a groove, and the anchoring body 106 includes at least one pin 144 (FIGS. 1C and 1D) that is positioned to travel along the track as the rotatable mount 104 is rotated. The track 142 can limit the rotation of the rotatable mount 104 and provide stops to rotation. In the illustrated embodiment, the track 142 and pin 144 limit rotation to 180 degrees (or 170, 175, 185, or 190 degrees or less). Any other suitable limit on the range of rotation can be used.

In at least some embodiments, the panel 112 includes one or more detents 145 for selected orientations of the rotatable mount 104 relative to the body 102. In at least some embodiments, each detent includes an indentation 146 on the panel 112 and protuberance 148 on the anchoring body 106. The protuberance 148 is shaped to fit in the indentation 146. In the illustrated embodiment, there are four indentations 146 on the panel and four protuberances 148 on the anchoring body and these are positioned at 90 degree intervals around the rotatable mount 146 and body 102. This arrangement facilitates positioning the mobile device 150 in the horizontal and vertical positions illustrated in FIGS. 3A and 3B. The detents 145 resist rotation of the mobile device 150 away from these preferred positions and the depth and size of the indentations 146 are selected to provide an amount of resistance, which, at least in some embodiments, is more than the expected gravitational force or other rotational force that is not provided by ta user. It will be understood that the location of any particular track 142, pin 144, indentation 146, or protuberance 148 can be on either the panel 112 and the rotatable mount 104 to provide opposing track/pin or indentation/protuberance pairs.

The above specification provides a description of the manufacture and use of the invention. Since many embodiments of the invention can be made without departing from the spirit and scope of the invention, the invention also resides in the claims hereinafter appended.

What is claimed as new and desired to be protected by Letters Patent of the United States is:

1. A dock for a mobile device, the dock comprising:
a base configured for attachment to a wall or other surface;
a rotatable mount rotatably coupled to the base, the rotatable mount comprising an anchoring mount and a bottom device receiver coupled to the anchoring mount, wherein the rotatable mount further comprises either a) a docking button indentation defined in the anchoring mount and configured for receiving a docking button coupled to the mobile device or b) a docking button extending from a remainder of the anchoring mount, wherein the bottom device receiver is configured to receive a bottom portion of the mobile device or a case containing the mobile device, wherein at least one of the bottom device receiver, the docking button indentation, or the docking button comprises a plurality of electrical contacts configured for making contact with contacts on the mobile device or the case containing the mobile device; and
a cord electrically coupled to at least one of the electrical contacts, extending into the base, and configured for coupling to a power source, a data source, or a data receiver.

2. The dock of claim 1, wherein the base comprises a wall box configured for insertion into a wall or other surface.

3. The dock of claim 2, wherein the base further comprises a power supply or a power over internet (PoE) injector, wherein the power supply or POE injector is electrically coupled to the cord.

4. The dock of claim 1, wherein the docking button indentation has a polygonal lateral cross-sectional shape.

5. The dock of claim 4, wherein the polygonal lateral cross-sectional shape is selected from triangular, square, rectangular, rhomboidal, trapezoidal, pentagonal, hexagonal, octagonal, or decagonal.

6. The dock of claim 1, wherein one of the base or rotatable mount defines a track and another one of the base or rotatable mount defines a pin arranged for traveling along the track to limit rotation of the rotatable mount relative to the base.

7. The dock of claim 1, wherein the rotatable mount or base is capable of, and limited to, a rotation of 180 degrees.

8. The dock of claim 1, wherein the rotatable mount or base is capable of, and limited to, a rotation of 90 degrees.

9. The dock of claim 1, wherein the base and rotatable mount comprise at least one detent for maintaining at least one desired rotation position of the rotatable mount relative to the base.

10. The dock of claim 1, wherein the docking button indentation or docking button includes a magnet or magnetically-attracted piece configured for magnetically coupling to a magnet or magnetically-attracted piece of the mobile device or case containing the mobile device to removably attach the mobile device to the dock.

11. A system, comprising:
the dock of claim 1; and
the mobile device.

12. A dock for a mobile device, the dock comprising:
a base configured for attachment to a wall or other surface;
a rotatable mount rotatably coupled to the base, the rotatable mount comprising an anchoring mount and a bottom device receiver coupled to the anchoring mount, the anchoring mount defining a docking button indentation for receiving a docking button coupled to the mobile device, wherein the bottom device receiver comprises a plurality of electrical contacts configured for making contact with contacts on the mobile device or the case containing the mobile device; and
a cord electrically coupled to at least one of the electrical contacts, extending into the base, and configured for coupling to a power source, a data source, or a data receiver.

13. The dock of claim 12, wherein the base comprises a wall box configured for insertion into a wall or other surface.

14. The dock of claim 13, wherein the base further comprises a power supply or a power over internet (PoE) injector, wherein the power supply or POE injector is electrically coupled to the cord.

15. The dock of claim 12, wherein the docking button indentation includes a magnet or magnetically-attracted piece configured for magnetically coupling to a magnet or magnetically-attracted piece of the mobile device or case containing the mobile device to removably attach the mobile device to the dock.

16. The dock of claim 12, wherein one of the base or rotatable mount defines a track and another one of the base or rotatable mount defines a pin arranged for traveling along the track to limit rotation of the rotatable mount relative to the base.

17. The dock of claim 12, wherein the base and rotatable mount comprise at least one detent for maintaining at least one desired rotation position of the rotatable mount relative to the base.

18. A method for attaching a mobile device to a wall or other surface, the method comprising:
removably attaching the mobile device to the dock of claim 1 which is attached to the wall or other surface; and
rotating the mobile device, while attached to the dock, relative to the wall or other surface.

19. The method of claim 18, wherein rotating the mobile device comprises rotating the mobile device at least 90 degrees.

20. The method of claim 18, further comprising charging the mobile device using the dock.
